(19) United States
(12) Patent Application Publication
(10) Pub. No.: US 2015/0191935 A1
(43) Pub. Date: Jul. 9, 2015

(54) ENVIRONMENT FRIENDLY METAL MECHANICAL PASSWORD LOCK CYLINDER CAPABLE OF SETTING REPEATED PASSWORD KEYS

(71) Applicant: Dongguan Suoan Industrial Co., Ltd., Dongguan City (CN)

(72) Inventors: Fenghao YANG, Dongguan City (CN); Qingbo TU, Dongguan City (CN)

(73) Assignee: Dongguan Suoan Industrial Co., Ltd., Dongguan City (CN)

(21) Appl. No.: 14/149,014

(22) Filed: Jan. 7, 2014

(51) Int. Cl. E05B 37/00

(52) U.S. Cl. CPC E05B 37/0048

(57) ABSTRACT

The invention provides an environment friendly metal mechanical password lock cylinder capable of setting repeated password keys, wherein the metal mechanical password lock cylinder is provided with an outer shell, a label panel, a positioning plate, a positioning plate spring, a buckle button reset plate, a buckle button reset plate spring, an axis, an axis panel, a control plate, a fastener locking plate, a plurality of password rebound leaves and a plurality of anti-theft rebound leaves; the two sides of the axis panel are provided with control plate balance reset devices; and the top of the axis panel is provided with a control plate height positioning device.

### FIELD OF THE INVENTION

The invention relates to the technical field of mechanical password locks, and in particular, to an environment friendly metal mechanical password lock cylinder capable of setting repeated password keys.

### BACKGROUND OF THE INVENTION

Along with social progress, password locks are applied more and more widely. However, an unlocking problem direct at the password lock is more and more severe. The password keys of the password locks on the current market can only set unrepeated passwords. Such a password lock has fewer password combinations and low unlocking difficulty. A Chinese invention patent “Flip-over Mechanical Password Anti-theft Lock” with a patent No. “ZL201010221684.X” just discloses such a mechanical password lock which can only set unrepeated passwords. This problem needs to be solved urgently.

### SUMMARY OF THE INVENTION

Direct at the defects of the prior art, the invention aims at providing a conveniently used environment friendly metal mechanical password lock cylinder capable of setting repeated password keys, which solves the foregoing problems.

The invention employs a technical solution as follows: the invention provides an environment friendly metal mechanical password lock cylinder capable of repeatedly setting password keys, wherein the metal mechanical password lock cylinder is provided with an outer shell, a label panel, a positioning plate, a positioning plate spring, a buckle button reset plate, a buckle button reset plate spring, an axis, an axis panel, a control plate, a fastener locking plate, a plurality of password rebound leaves and a plurality of anti-theft rebound leaves. The two sides of the axis panel are provided with control plate balance reset devices. The top of the axis panel is provided with a control plate height positioning device. The back of the axis panel is provided with a plurality of control plate limiting devices. The edge line of the part of the password rebound leaf inserted into the control plate presents a 40-70 degree angle relative to the plane. The lower side of the part of the password rebound leaf inserted into the control plate is provided with a plurality of positioning blocks.

Preferably, 1 to 4 positioning blocks are arranged.

Preferably, the control plate balance reset devices are balance tension springs that are symmetrically arranged left and right.

Preferably, the control plate height positioning device is a height positioning screw.

Preferably, a first groove and a second groove are arranged on the password rebound leaf and the anti-theft rebound leaf.

The invention has the beneficial effects as follows:

The environment friendly metal mechanical password lock cylinder capable of setting repeated password keys is a metal mechanical structure, which is durable to use, does not need to use any power supply, saves energy and is environment friendly; the environment friendly metal mechanical password lock cylinder capable of setting repeated password keys can be widely applied to multiple usages such as door lock, safe lock, cabinet lock and auto lock; and the password sequence arrangement keys of the environment friendly metal mechanical password lock cylinder capable of setting repeated password keys can be repeatedly set for a plurality of times, so that password combination quantity presents a geometric growth, thus enhancing the door lock security.

### BRIEF DESCRIPTION OF THE DRAWINGS

FIG. 1 is a structural diagram of an environment friendly metal mechanical password lock cylinder capable of setting repeated password keys of the invention;

FIG. 2 is an exploded view of the environment friendly metal mechanical password lock cylinder capable of setting repeated password keys of the invention;

FIG. 3 is a structural diagram of embodiment 1 of the environment friendly metal mechanical password lock cylinder capable of setting repeated password keys of the invention;

FIG. 4 is a structural diagram of embodiment 2 of the environment friendly metal mechanical password lock cylinder capable of setting repeated password keys of the invention;

FIG. 5 is a structural diagram of embodiment 3 of the environment friendly metal mechanical password lock cylinder capable of setting repeated password keys of the invention; and

FIG. 6 is a structural diagram for password rebound leaves of the environment friendly metal mechanical password lock cylinder capable of setting repeated password keys of the invention to repeatedly clamp a control plate.

### DETAILED DESCRIPTIONS OF THE PREFERRED EMBODIMENTS

The invention will be described hereinafter with reference to the specific embodiments.

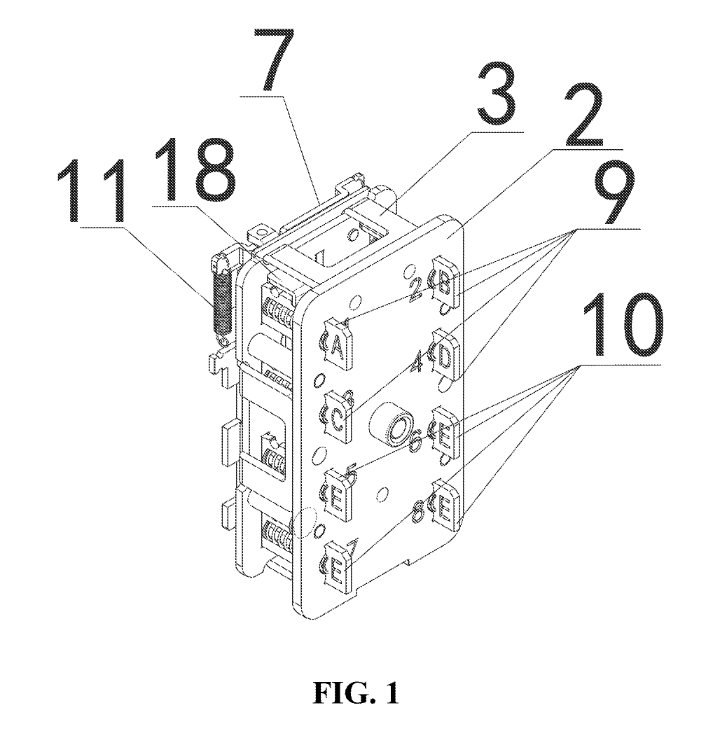

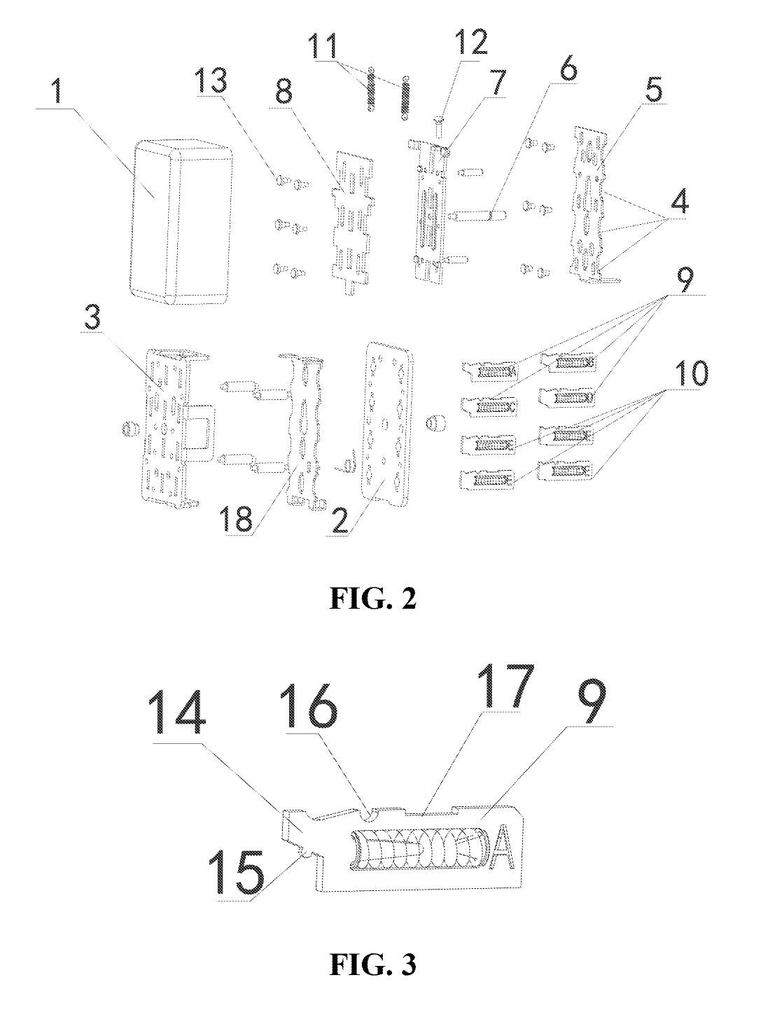

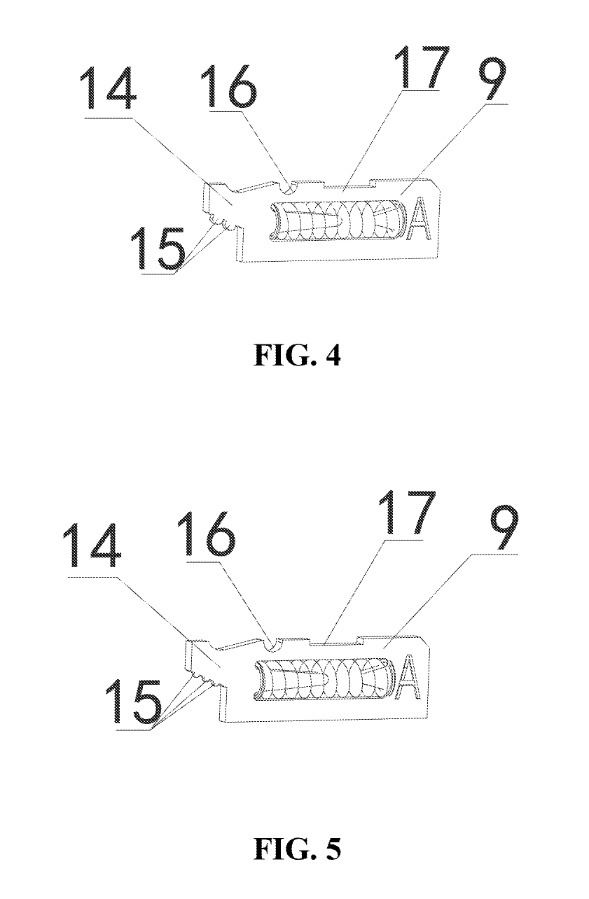

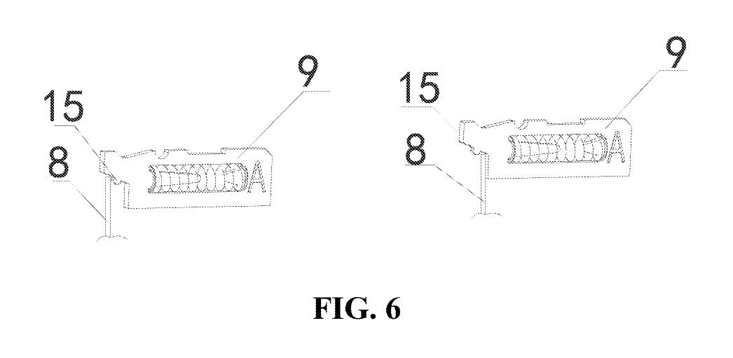

As shown in FIGS. 1, 2, 3, 4, 5 and 6, the invention provides an environment friendly metal mechanical password lock cylinder capable of repeatedly setting password keys, wherein the metal mechanical password lock cylinder is provided with an outer shell 1, a label panel 2, a positioning plate 3, a positioning plate spring, a buckle button reset plate 5, a buckle button reset plate spring, an axis 6, an axis panel 7, a control plate 8, a fastener locking plate 18, a plurality of password rebound leaves 9 and a plurality of anti-theft rebound leaves 10; the two sides of the axis panel 7 are provided with control plate balance reset devices 11. The top of the axis panel 7 is provided with a control plate height positioning device 12. The back of the axis panel 7 is provided with a plurality of control plate limiting devices 13. The edge line of the part 14 of the password rebound leaf 9 inserted into the control plate presents a 40-70 degree angle relative to the plane. The lower side of the part 14 of the password rebound leaf inserted into the control plate is provided with a plurality of positioning blocks 15.

1 to 4 positioning blocks 15 are arranged.

The control plate 8 balance reset devices are balance tension springs that are symmetrically arranged left and right.

Preferably, the control plate height positioning device 12 is a height positioning screw.

Preferably, a first groove 16 and a second groove 17 are arranged on the password rebound leaf 9 and the anti-theft rebound leaf 10.

The course of work is as follows:

When the environment friendly metal mechanical password lock cylinder capable of repeatedly setting password keys is used, various keys such as figures from 1 to 9 or English letters from A to Z may be selected according to different key position requirements. Moreover, different geometrical shapes may be arranged with small size. The environment friendly metal mechanical password lock cylinder capable of repeatedly setting password keys can be conveniently used on various doors and door locks, safe locks, cabinet locks and auto locks, and is very convenient to use.

When inputting the passwords, the password rebound leaves 9 on the label panel are pressed according to a preset sequence. The password rebound leaves 9 are horizontally slipped in the label panel 2. Under the effect of the part 14 of the tail of the password rebound leaf, the control plate 8 moves downwards. The first groove 16 is clamped by a positioning hole 4 on the buckle button reset plate 5. In this way, the password rebound leaves 9 are continuously inputted, and the parts 14 of the tail of the password rebound leaves are gradually broadened with the arrangement, thus pushing the control plate 8 to press down a connecting rod, so as to complete an unlocking motion.

When inputting the passwords not according to the arrangement sequence, the first groove 16 on the pressed anti-theft rebound leaf 10 is also clamped by the positioning hole 4 on the buckle button reset plate 5, with hand feeling and sound completely the same with that of the password rebound leaf 9 when being pressed. However, the anti-theft rebound leaf 10 can only push the control plate 8 backwards rather than making the control plate move downwards.

When requiring reset, the flip-over lock cylinder control plate can be reset as long as randomly pressing the anti-theft rebound leaves 10 or upwards pushing the buckle button reset plate 5.

The lower side of the part 14 of the password rebound leaf 9 of the invention inserted into the control plate is provided with the plurality of positioning blocks 15. Such a structure enables the password rebound leaf 9 to downwards press the control plate 8 for a plurality of times, so that the password keys can be repeatedly set.

The part 14 of the password rebound leaf 9 inserted into the control plate firstly pushes the control plate 8 downwards. Then the first groove 16 of the password rebound leaf 9 is clamped by the positioning hole 4 on the buckle button reset plate 5. Afterwards, next password rebound leaf 9 is pressed. The foregoing process is repeated. When the control plate 8 is clamped by next password rebound leaf 9, the first password rebound leaf 9 is pushed again to push the control plate 8 through the positioning block 15 to clamp the control plate, so as to complete a password key repeating process. Then the password rebound leaves 9 are pushed in sequence till unlocking.

The angle of the edge line of the part 14 of the password rebound leaf 9 of the invention inserted into the control plate can be adjusted. Moreover, the top of the axis panel 7 of the invention is provided with the control plate height positioning device 12, which may adjust the height of the control plate 8 according to the angle of the edge line of the part 14 of the password rebound leaf 9 inserted into the control plate, and cooperate with the setting of the password rebound leaf 9.

The fastener locking plate 18 may realize dual locking of the password rebound leaves 9 and the anti-theft rebound leaves 10, and may fix the password rebound leaves 9 and the anti-theft rebound leaves 10 on position.

The password sequence arrangement keys corresponding to the password rebound leaves 9 of the invention may be repeatedly set for a plurality of times, so that password combination quantity presents a geometric growth, thus enhancing the door lock security.

The foregoing embodiments are merely preferred embodiments of the invention, but are not intended to limit the implementation and protection scope of the invention. Any equivalent variation and modification made according to the contents of the patent protection scope of the invention shall fall into the patent scope of the invention.

What is claimed is:

1. An environment friendly metal mechanical password lock cylinder capable of setting repeated password keys, wherein the metal mechanical password lock cylinder is provided with an outer shell, a label panel, a positioning plate, a positioning plate spring, a buckle button reset plate, a buckle button reset plate spring, an axis, an axis panel, a control plate, a fastener locking plate, a plurality of password rebound leaves and a plurality of anti-theft rebound leaves; the two sides of the axis panel are provided with control plate balance reset devices; the top of the axis panel is provided with a control plate height positioning device; the back of the axis panel is provided with a plurality of control plate limiting devices; the edge line of the part of the password rebound leaf inserted into the control plate presents a 40-70 degree angle relative to the plane; and the lower side of the part of the password rebound leaf inserted into the control plate is provided with a plurality of positioning blocks.

2. The environment friendly metal mechanical password lock cylinder capable of setting repeated password keys according to claim 1, wherein 1 to 4 positioning blocks are arranged.

3. The environment friendly metal mechanical password lock cylinder capable of setting repeated password keys according to claim 1, wherein the control plate balance reset devices are balance tension springs that are symmetrically arranged left and right.

4. The environment friendly metal mechanical password lock cylinder capable of setting repeated password keys according to claim 1, wherein the control plate height positioning device is a height positioning screw.

5. The environment friendly metal mechanical password lock cylinder capable of setting repeated password keys according to claim 1, a first groove and a second groove are arranged on the password rebound leaf and the anti-theft rebound leaf.
